(19) United States
(12) Patent Application Publication
(10) Pub. No.: US 2008/0082267 A1
(43) Pub. Date: Apr. 3, 2008

(54) Vehicle wheel track indication system

(76) Inventor: Shih-Lung Hsu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/541,773

(22) Filed: Oct. 3, 2006

(51) Int. Cl. G08G 1/16

(52) U.S. Cl. 701/301

(57) ABSTRACT

A vehicle wheel track indication system including two adjustment devices and two indication devices is provided. Each of the adjustment devices includes a base, an adjusting unit pivoted on the base and an angular control unit mounted between the base and the adjusting unit to swing the adjusting unit. The indication devices are located on the adjusting unit of the adjustment device, and each of the indication devices includes at least one laser emitter. The laser emitters emit visible rays and correspond to the front wheels of the vehicle. The angle of the indication device is adjusted by the adjusting unit to change an emitted ray distance. Consequently, the driver can identify the front wheel track to dodge road recesses or road bumps.

### BACKGROUND

1. Field of Invention

The present invention relates to a light emitting device, and more particularly to a vehicle wheel track indication system for a driver to identify a front wheel track when driving.

2. Description of Related Art

Drivers usually dodge road recesses or road bumps when driving. However, depending on the visibility, dodging the road barriers may still not be the appropriate way. When the size of the road recesses or road bumps are very close to the front wheel track, the drivers, especially beginners, cannot steer the vehicle to dodge the road bumps if they only depend on their visibility.

Therefore, a vehicle headlamp with laser indication has been developed. The laser indication uses laser emitters respectively mounted at the positions near to the left headlamp and the right headlamp. With this method, parallel visible light beams are emitted by the laser emitters and are close to the front wheel track. The laser beams help the drivers to determine whether the vehicle can pass through the road barrier or not. Thus, driving safety can be enhanced.

Nevertheless, this conventional indication system does not include an angular control device. The visual scopes of the drivers are different and depend on the drivers' heights. The conventional indication system cannot meet the requirements of drivers with different heights. Consequently, an indication system with high accuracy is needed for the drivers to identify the front wheel track to dodge the road bumps or recesses.

### SUMMARY

It is therefore an objective of the present invention to provide an indication system for vehicles to help accurately measure the front wheel track of the vehicle so that the driver will easily dodge road bumps or recesses.

An indication system for a vehicle, such as a car, is mounted at the front of the car. The indication system includes two adjustment devices and two indication devices. Each of the adjustment devices includes a base, an adjusting unit and an angular control unit. The adjusting unit is pivotally mounted on the base. The angular control unit is mounted between the base and the adjusting unit to swing the adjusting unit. In addition, the indication device is located on the adjusting unit of the adjustment device. Each of the indication devices includes at least one laser emitter that emits a visible light beam. The light beams correspond to the front wheel track of the vehicle. Furthermore, the indications respectively correspond to inner edges of the front wheels.

As a result, the indication system is mounted in the bumper and corresponds to the front wheels to emit visible light beams on the road surface. The track between the wheels is accurately identified for the driver to dodge the road bumps or recesses such that the driving safety of the driver is enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a rear view of the embodiment of the indication system of the invention;

FIG. 2 shows a partial sectional side view of the embodiment of the indication system of the invention;

FIG. 3 shows a same view in accordance with FIG. 2 to illustrate the indication device shifts the angle by the adjusting unit;

FIG. 4 shows circuit diagram of the embodiment of the present invention;

FIG. 5 shows a section view of the indication device of the present invention;

FIG. 6 shows a section view of another embodiment of the indication device of the present invention;

FIG. 7 shows an operational perspective view of the power switch and the fine tuner mounted in the light controller;

FIG. 8 shows a side view of the vehicle with the indication system of the present invention; and

FIG. 9 shows a top view of the vehicle with the indication system of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

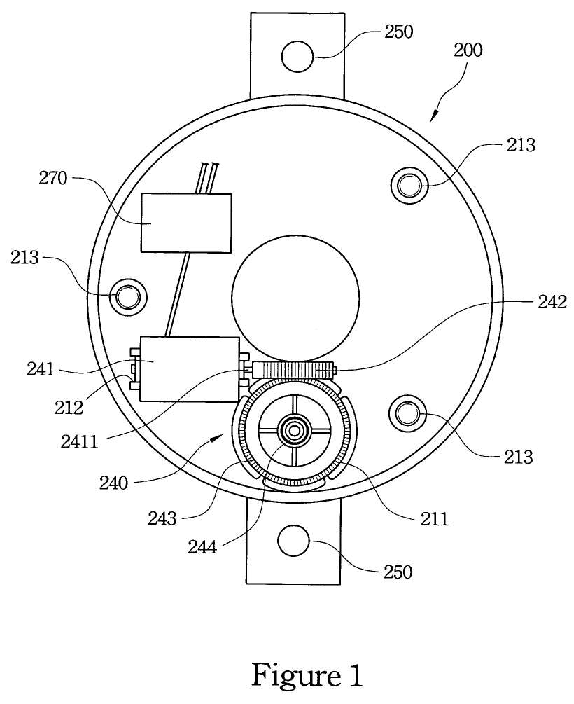

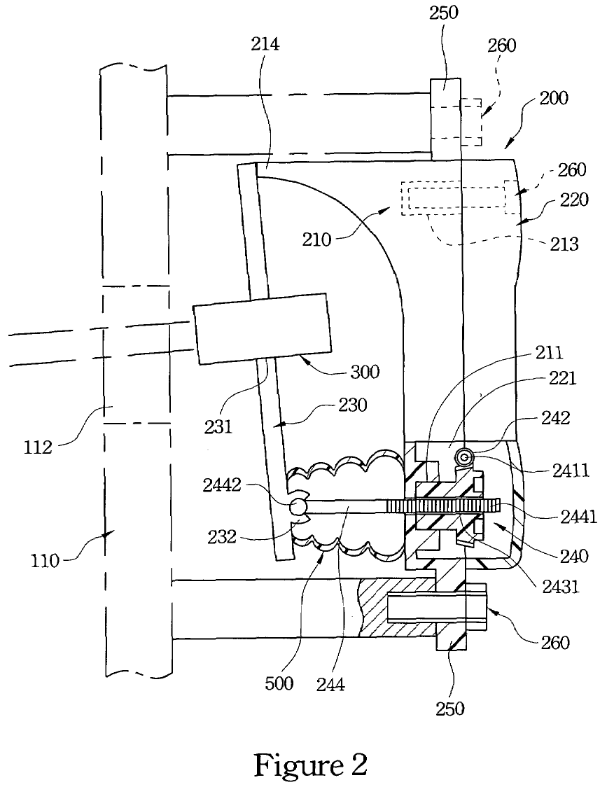

Refer to FIG. 1 and FIG. 2. FIG. 1 is a rear view illustrating the embodiment of the indication system of the present invention. FIG. 2 is partial sectional side view illustrating the embodiment of the indication system of the invention.

The indication system is mounted at the front of a vehicle, such as in a front bumper 110 (or back view mirror) of a vehicle 100 and is oriented to face the front. The indication system includes two adjustment devices 200 and two indication devices 300 respectively and mounted on the opposite sides. There is only one adjustment device 200 and one indication device 300 as illustrated in FIG. 1 and FIG. 2 because the adjustment devices 200 have the same structure, and the indication devices 300 also have the same structure.

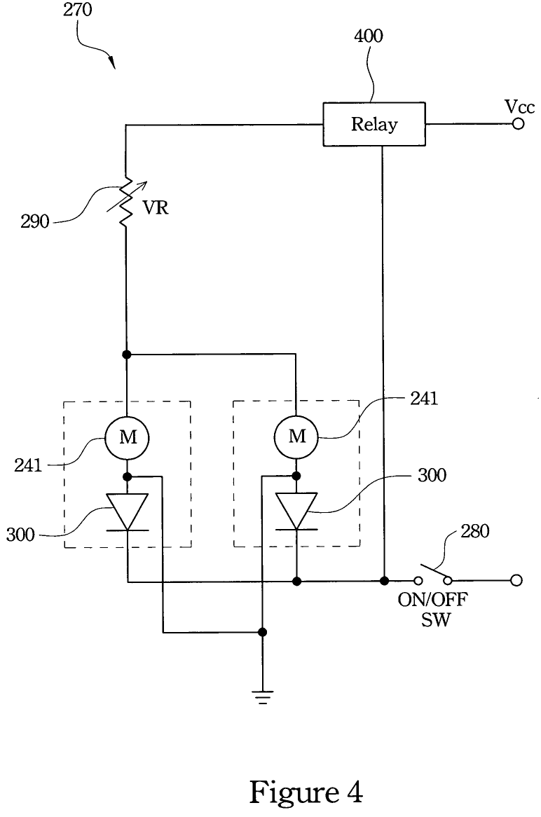

Refer to FIG. 1, FIG. 2 and FIG. 4. FIG. 4 is a circuit diagram illustrating the embodiment of the present invention.

The adjustment device 200 includes a base 210, a cover 220, an adjusting unit 230, an angular control unit 240, two locking portions 250, multiple locking members 260, a control circuit 270, a power switch 280 and a fine tuner 290. The adjusting unit 230 is pivotally mounted on the base 210. The angular control unit 240 is mounted between the base 210 and the adjusting unit 230. The locking portions 250 are formed outside the base 210.

The base 210 includes a position trench 211, a position trench 212, multiple locking portions 213 and a pivoted portion 214.

The adjusting unit 230 includes a sleeve 231 for fixing the indication device 300 and a joint 232.

The angular control unit 240 includes a motor 241, a worm 242, a gear 243 and a spindle 244. The motor 241 is mounted in the position trench 212 of the base 210. The worm 242 is connected to a shaft 2411 of the motor 241. The gear 243 is rotatably mounted in the position trench 211 of the base 210 and is engaged with the worm 242. The spindle 244 is driven by the motor 241 and connected between the gear 243 and the adjusting unit 230. The spindle 244 has a threaded end 2441 threadedly connected with the threaded hole 2431 and a ball end 2442 locked in the joint 232 of the adjusting unit 230.

Refer to FIG. 1 and FIG. 2. The cover 220 houses the base 210 to define a room 221. Thus, the motor 241, the worm 242, the gear 243 and part of the spindle 244 are covered inside the room 221.

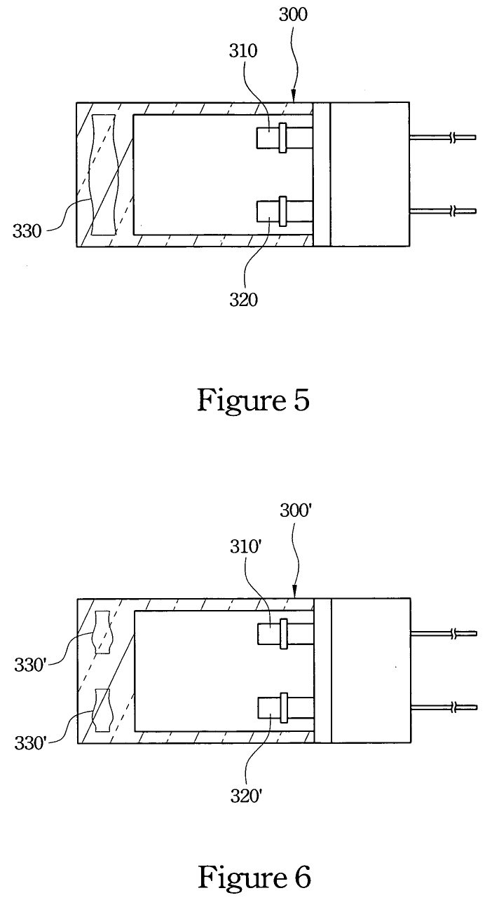

Refer to FIG. 5 and FIG. 6. FIG. 5 is a sectional view illustrating the indication device of the present invention. FIG. 6 is a sectional view illustrating another embodiment of the indication device of the present invention. The indication device 300 includes two laser emitters 310 and 320. The first laser emitter 310 can emit a red ray and the second laser emitter 320 can emit a green ray. In FIG. 5, the indication device 300 has a convex lens 330 corresponding to the laser emitters 310 and 320. In FIG. 6, the indication device 300′ has two convex lenses 330′ corresponding respectively to the laser emitter 310′ and the laser emitter 320′. The convex lens is used to condense the ray emitted from the laser emitter 310 and the laser emitter 320.

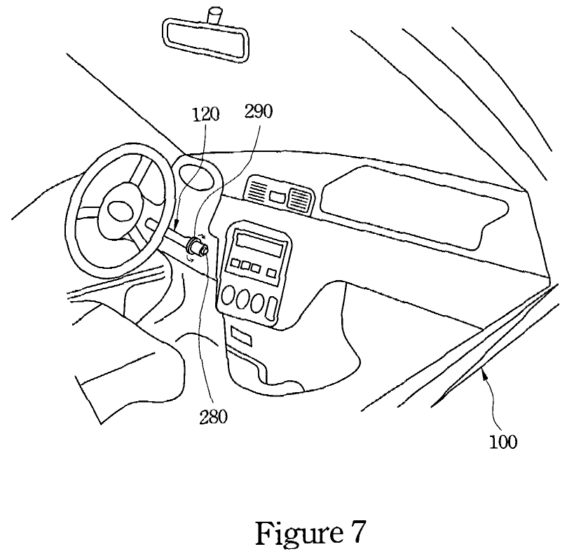

Refer to FIG. 7. FIG. 7 is a perspective view illustrating the power switch 280 and the fine tuner 290 mounted in the light controller 120 of the vehicle 100.

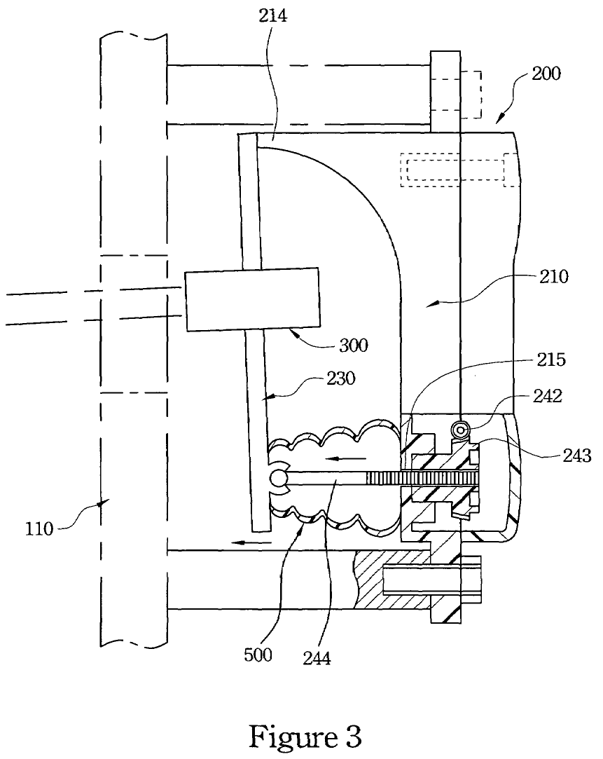

Refer to FIG. 2 and FIG. 3. The adjustment device 200 further includes a waterproof sleeve 500 covering the spindle 244 and connected between the base 210 and the adjusting unit 230. Accordingly, moisture is prevented from entering the aperture 215 such producing a waterproof effect.

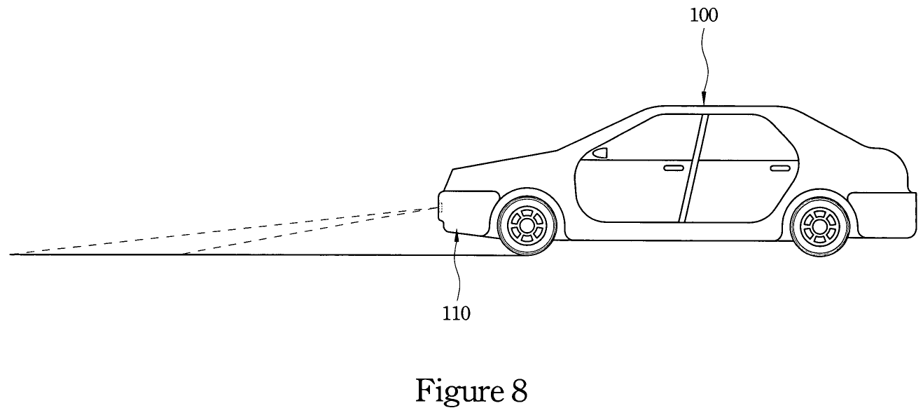

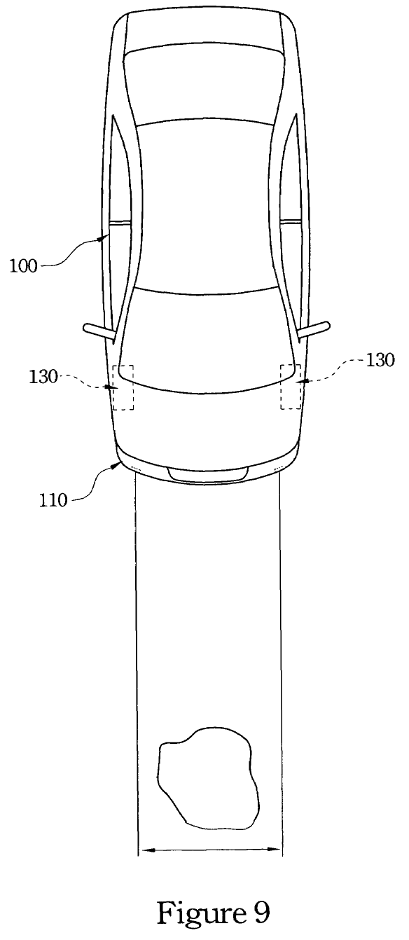

Refer to FIG. 2, FIG. 8 and FIG. 9. FIG. 8 is a side view of the vehicle with the indication system to illustrate the emitted ray with different distance. FIG. 9 is a top view of the vehicle with the indication system. The locking members 260 fasten the locking portion 250 of the adjustment device 200 in the front bumper 110 of the vehicle 100. The laser emitters are correspondingly set on the opposite terminals according to the inner edges of the front wheels.

Refer to FIG. 4 and FIG. 7. When the power switch is closed, a relay 400 drives the fine tuner 290 (an adjustable resistor VR). Refer to FIG. 1 and FIG. 2. The fine tuner 290 enacts the control circuit 270. The control circuit 270 is a laser drive circuit driving the laser emitters 310, 320 of the indication device 300. Refer to FIG. 2 and FIG. 8. The fine tuner 290 is kept in a low level such that the emitted ray, emitted from the indication device 300 and passed through a light-transmitting layer 112 of the bumper 110, is kept in a short distance. Refer to FIG. 3, FIG. 7 and FIG. 8. When the fine tuner 290 is adjusted clockwise to a higher level, the motor 241 rotates the worm 242. The rotation of the worm 242 rotates the gear 243. The rotating gear 243 drives the spindle 244 such that the spindle 244 is moved forward to adjust the adjusting unit 230. Therefore, the adjusting unit 230, based on the pivoted portion 214, is pushed to produce a swing effect to alter the emitted ray angle. By this method, the emitted ray is kept in a long distance. As a result, the level of the fine tuner 290 alters the emitted ray angle to adjust the distance of the emitted ray.

Refer to FIG. 9. The track between the front wheels 130 of the vehicle 100 is identified accurately by the driver with the emitted ray from the indication devices 300. In this way, the driver can conveniently dodge road recesses or road bumps to prevent vehicle damage and degradation. Drivers with various heights can determine the appropriate emitted ray angle by adjusting the fine tuner 290.

The red laser emitter 310 and the green laser emitter 320 disposed in the indication device 300 emit the rays simultaneously. The red spot is more indistinguishable than the green spot in the daytime. Thus, the driver can identify the track by observing the green spots with high visibility in the daytime. In addition, the red spots and the green spots have high visibility during the nighttime such that the driver is capable of identifying the spots with double color spots method.

According to the composition and the embodiments above, the indication devices 300 are respectively mounted in the bumper 110 of the vehicle 100 and corresponding to the wheels 130. In this way, the driver can identify the minimal track between the wheels 130 with the red and the green rays emitted form the indication devices 300. Therefore, the driver can dodge the road recesses or road bumps more conveniently. Furthermore, the driver can operate the power switch 280 and the fine tuner 290 mounted in the light controller 120 to control the indication device 300. The angle of the indication device 300 is controlled by the adjusting unit 230 to adjust the emitted ray distance. Thus, the drivers with various heights can determine the appropriate emitted ray angle by this method such that the driving safety is enhanced.

Although the present invention has been described in considerable detail with reference to certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An indication system for a vehicle, comprising:
two adjustment devices, and each of the adjustment devices including
a base;
an adjusting unit pivotally mounted on the base; and
an angular control unit mounted between the base and the adjusting unit to adjust an angle of the adjusting unit; and
two indication devices respectively mounted on the adjusting units, and each of the indication devices including
at least one laser emitter to emit visible rays and corresponding to the front wheel of the vehicle;
whereby, the angle of the indication device is adjusted with the adjusting unit to change an emitted ray distance.

2. The indication system of claim 1, wherein the angular control unit of the adjustment device includes a motor mounted on the base and a spindle driven by the motor and connected with the adjusting unit.

3. The indication system of claim 2, wherein the angular control unit of the adjustment device further includes a worm connected to and rotated by the motor, and a gear engaged with the worm.

4. The indication system of claim 3, wherein the spindle has a threaded end adjustably mounted and held in a center threaded hole of the gear, and a ball end pivotally connected to a joint of the adjusting unit.

5. The indication system of claim 4, wherein the adjustment device further includes a control circuit, and a power switch electrically connected with the control circuit and mounted in a light controller inside the vehicle.

6. The indication system of claim 5, wherein the adjustment device further includes a fine tuner electrically connected with the control circuit and mounted in the light controller inside the vehicle.

7. The indication system of claim 1, wherein one of the at least one laser emitter emits a red ray and one of the at least one laser emitter emits a green ray.

8. The indication system of claim 7, wherein the indication devices further include at least one convex lens respectively corresponding to the at least one laser emitter and mounted ahead of the corresponding laser emitter.

9. The indication system of claim 1, wherein each of the adjustment devices further includes two locking portions formed outside the base and multiple locking members fastening the locking portions on the vehicle.

10. The indication system of claim 9, wherein each of the adjustment devices further includes a cover housing on the base to define a room that holds the motor and the spindle inside.

11. The indication system of claim 8, wherein the at least one laser emitter is mounted at a position corresponding to an inner edge of one of the front wheels of the vehicle.
